(19) United States
(12) Patent Application Publication
(10) Pub. No.: US 2009/0211608 A1
(43) Pub. Date: Aug. 27, 2009

(54) LIQUID INJECTION INTO GAS STREAM

(76) Inventor: Keith Roscoe, Cheshire (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/914,898

(22) PCT Filed: May 17, 2006
(86) PCT No.: PCT/GB2006/001816

§ 371 Date: Jul. 14, 2008

(30) Foreign Application Priority Data
May 17, 2005 (GB) 0510021.9

(51) Int. Cl. B08B 9/027

(52) U.S. Cl. 134/22.11; 134/166 C

(57) ABSTRACT

A liquid injection device (11) for injecting cleaning liquids into an airflow, comprises: an airflow duct (12); a jacket (13) surrounding the airflow duct, in two parts (13a, 13b), axially separable, and having liquid infeed and drain openings (15); at least one nozzle unit (16) having an inlet opening (16a) onto the jacket, and its nozzle outlet opening (16b) into the airflow duct; the parts of the jacket being sealingly juxtaposed for use, and separable for access to said nozzle unit.

This invention relates to injecting liquids into a gas stream, and has particular application to pipe clearing and cleaning and general surface cleaning using cleaning fluids such as water with detergent and organic solvents in a ‘lean phase’ mode.

In pipe clearing according to WO 0117700, pipe content is displaced by a first, high pressure (order of 1 bar), low speed air flow, which, depending on the nature of the contents, displaces contents as a plug, followed by a low pressure, high velocity (order of 5 m/s) airflow, which strips the pipe wall of most residual content. Usually, a film remains, which must be removed by washing. Washing in the usual way, by sending quantities of washing liquid though the pipe, is wasteful of washing liquid, and gives rise to disposal problems. Where the washing liquid is an organic solvent, or, for certain materials, such as scale in sub-sea oil pipelines, strong acids or caustic solutions, the quantities of washing liquids used can occasion environmental problems, and may, in certain applications, be prohibited by environmental regulations.

The use of large quantities of liquids can be avoided by presenting them as a mist of droplets and swirling the airflow so that the droplets contact the pipe wall.

The present invention provides a device particularly adapted to introducing liquids in controlled amounts into an airflow for the purpose of cleaning pipe walls (and, indeed, other surfaces) by lean phase mode cleaning techniques.

The invention comprises a liquid injection device for injecting cleaning liquids into an airflow, comprising:
an airflow duct;
a jacket surrounding the airflow duct, in two parts, axially separable, and having liquid infeed and drain openings;
at least one nozzle unit having an inlet opening onto the jacket, and its nozzle outlet opening into the airflow duct;
the parts of the jacket being sealingly juxtaposed for use, and separable for access to said nozzle unit.

The airflow duct may have, at each end, unions for connection in a cleaning arrangement.

The juxtaposed parts of the jacket may have flanges for connection to each other, the flanges having ring seals.

One part of the jacket, which, when juxtaposed to the other, surrounds the nozzle, may be slidable along the airflow duct to expose the nozzle. In another arrangement, the airflow duct may itself be in two parts, one part, having the nozzle, being separable from the other together with one part of the jacket so as to expose the nozzle.

In use, to inject liquid into an airflow through the duct, the jacket, the jacket is supplied with liquid, at least to the level of the nozzle inlet. The jacket may, of course, be filled with liquid. The flow of liquid may be controlled by controlling the pressure of the liquid in the jacket, or by positively feeding liquid to the jacket at a predetermined rate, which may be dependent on the rate at which air flows through the airflow duct.

The rate at which liquid can flow through the nozzle may well depend on the nozzle characteristics. The design of the device makes it easy to change nozzles, the airflow duct wall being drilled and tapped, or otherwise adapted, to receive a nozzle of easy removal and substitution.

Embodiments of liquid injection devices according to the invention will now be described with reference to the accompanying drawings, in which:

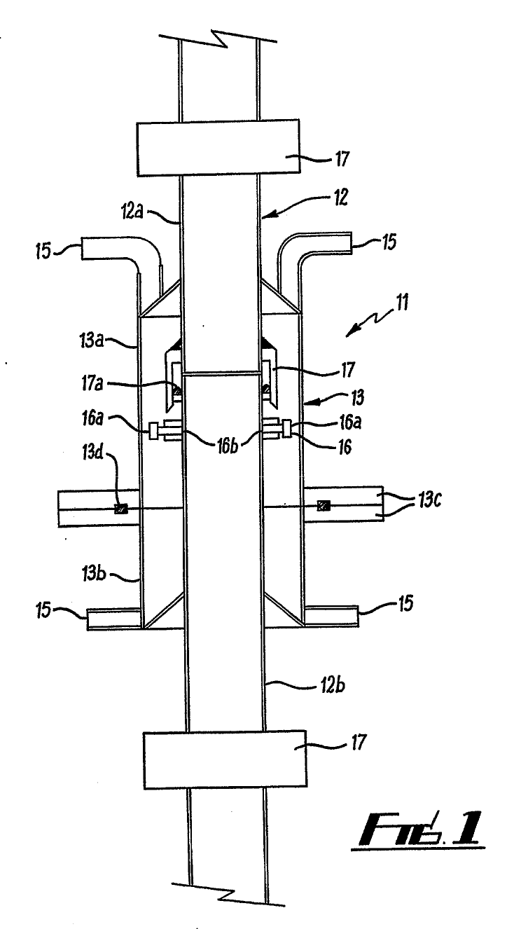

FIG. 1 is an axial section through a first embodiment;

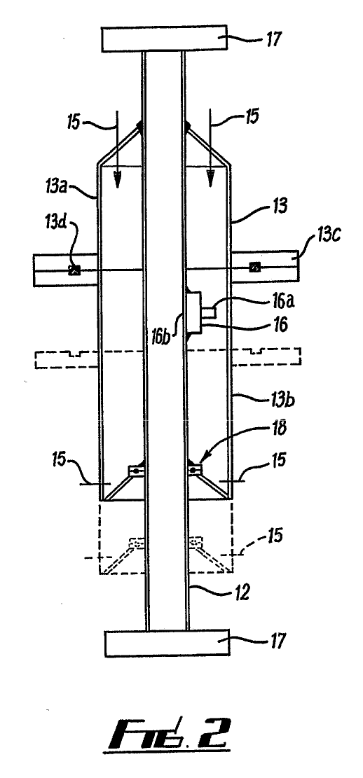

FIG. 2 is an axial section through a second embodiment; and

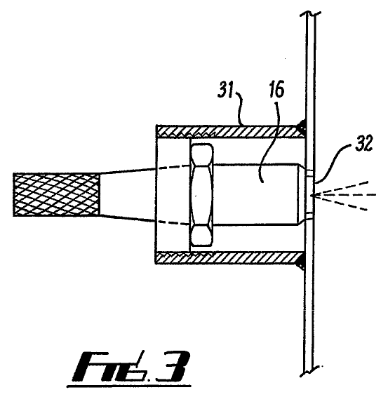

FIG. 3 is an axial section through a nozzle and its location arrangement in an airflow duct wall.

The drawings illustrate a liquid injection device 11 for injecting cleaning liquids into an airflow, comprising:
an airflow duct 12;
a jacket 13 surrounding the airflow duct 12, in two parts, 13a, 13b, axially separable, and having liquid infeed and drain openings 15;
at least one nozzle unit 16, having an inlet 16a opening into the jacket, and its nozzle outlet 16b opening into the airflow duct 12;
the parts 13a, 13b of the jacket 13 being sealingly juxtaposed for use, and separable for access to said nozzle unit 16.

In this embodiment, there are two nozzles 16.

The airflow duct 12 has, at each end, unions 17 for connection in a cleaning arrangement.

The juxtaposed parts 13a, 13b of the jacket 13 have flanges 13c for connection to each other, the flanges having a ring seal 13d.

In the embodiment illustrated in FIG. 1, the airflow duct 12 is also in two parts, one part, 12b, having the nozzle, being separable from the other, 12a, together with part 13b of the jacket so as to expose the nozzles 16. A sealing shroud 17, with an O-ring seal 17a, seals the join of the parts 12a, 12b of the airflow duct 12.

In use, liquid to be fed into the airflow duct 12 is introduced into the jacket 13 through the infeed and drain openings 15. The jacket can be maintained at any desired pressure and temperature so that the liquid enters the airflow duct 12 at a desired rate and in a desired state.

In the embodiment of FIG. 2, the airflow duct 12 is not divided. The part 13b of the jacket 13 slides along the duct 12—see the broken line position—away from part 13a. When juxtaposed, the jacket is sealed by the flanges 13c, with O-ring seal 13d, as before, and also by a sealed flange arrangement 18.

Other arrangements are, of course, possible, with the division of the jacket and/or the airflow duct in locations other than those illustrated.

FIG. 3 illustrates the nozzle 16 arrangement. A nozzle, such as a Delavan® type nozzle is mounted in a threaded bush 31 welded to the outer face of the airflow duct 12 and delivers through an aperture 32 in the duct wall. A filter can be fitted, if desired, within the space of the jacket.

The arrangements illustrated provide a simple, but easily accessed and serviced, means of ensuring controlled flow of liquid into an airflow for cleaning purposes. In carrying out operations according to WO0117700, cleaning liquids such as water with added detergent or organic solvents are added in droplet form to a high speed airflow to be swirled around the inner face of a pipe or other duct to be cleaned, and the arrangements are adapted to enable the cleaning liquid to be accurately dispensed and to enter the airflow according to the requirements of the cleaning process.

1. A liquid injection device for injecting cleaning liquids into an airflow, comprising:
an airflow duct;
a jacket surrounding the airflow duct, in two parts, axially separable, and having liquid infeed and drain openings;
at least one nozzle unit having an inlet opening onto the jacket, and its nozzle outlet opening into the airflow duct;
the parts of the jacket being sealingly juxtaposed for use, and separable for access to said nozzle unit.

2. A device according to claim 1, in which the airflow duct has, at each end, unions for connection in a cleaning arrangement.

3. A device according to claim 1 or claim 2, in which the juxtaposed parts of the jacket have flanges for connection to each other, the flanges having ring seals.

4. A device according to any one of claims 1 to 3, in which one part of the jacket, which, when juxtaposed to the other, surrounds the nozzle, is slidable along the airflow duct to expose the nozzle.

5. A device according to any one of claims 1 to 3, in which the airflow duct is itself in two parts, one part, having the nozzle, being separable from the other together with one part of the jacket so as to expose the nozzle.

6. A method for injecting liquid into an airflow, using a device according to any one of claims 1 to 5, in which the jacket is supplied with liquid, at least to the level of the nozzle inlet.

7. A method according to claim 8, in which the jacket is filled with liquid.

8. A method according to claim 6 or claim 7, in which the flow of liquid is controlled by controlling the pressure of the liquid in the jacket.

9. A method according to claim 6 or claim 7, in which the flow of liquid is controlled by positively feeding liquid to the jacket at a predetermined rate.

10. A method according to claim 9, in which said predetermined rate is dependent on the rate at which air flows through the airflow duct.
